(19) United States
(12) Patent Application Publication
(10) Pub. No.: US 2009/0172734 A1
(43) Pub. Date: Jul. 2, 2009

(54) BROADCAST RECEIVING APPARATUS AND BROADCAST RECEIVING METHOD

(75) Inventor: Kazuki Kuwahara, Fukaya-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/192,893

(22) Filed: Aug. 15, 2008

(30) Foreign Application Priority Data
Dec. 26, 2007 (JP) 2007-335133

(51) Int. Cl. H04N 5/445; H04N 7/26

(52) U.S. Cl. 725/39; 386/124; 386/E05.001

(57) ABSTRACT

A broadcast receiving apparatus includes: a storage module storing a table correspondingly showing a program identifier identifying a broadcast program, and a broadcast start time of the program; a detecting module detecting whether the broadcast start time is brought forward or not based on program guide information acquired from a broadcast signal and the program identifier; a video-recording module starting a video-recording of the program at the broadcast start time which is brought forward when the bringing-forward is detected; and a reproduction module reproducing the video-recorded program at the broadcast start time before it is brought forward.

### CROSS-REFERENCE TO THE APPLICATIONS

This application is based upon and claims the benefit of priority from the prior Japanese Patent Application No. 2007-335133, filed on Dec. 26, 2007; the entire contents of which are incorporated herein by reference.

### BACKGROUND OF THE INVENTION

1. Field of the Invention

The present invention relates to a broadcast receiving apparatus and a broadcast receiving method receiving a broadcast.

2. Description of the Related Art

A broadcast receiving apparatus receiving a broadcast and viewing a program is used. Here, an art relating to an information processing apparatus changing a start time of execution of a reserved process when a program start time of a reserved program is changed is disclosed (refer to JP-A 2005-65052(KOKAI)).

### BRIEF SUMMARY OF THE INVENTION

Incidentally, there is a case when a reproduction of a program is started at a predetermined time to thereby notify a user of an arrival of time (on-timer). At this time, the user cannot view a desired program when the reproduction is started if a start time of the program is brought forward. An object of the present invention is to provide a broadcast receiving apparatus and a broadcast receiving method capable of reproducing the desired program at the predetermined time even when the start time of the program is brought forward.

A broadcast receiving apparatus according to an aspect of the present invention includes: a storage module storing a table correspondingly showing a program identifier identifying a broadcast program, and a broadcast start time of the program; a detecting module detecting whether the broadcast start time is brought forward or not based on program guide information acquired from a broadcast signal and the program identifier; a video-recording module starting a video-recording of the program at the broadcast start time which is brought forward when the bringing-forward is detected; and a reproduction module reproducing the video-recorded program at the broadcast start time before it is brought forward.

A broadcast receiving method according to an aspect of the present invention includes: storing a table correspondingly showing a program identifier identifying a broadcast program, and a broadcast start time of the program; detecting whether the broadcast start time is brought forward or not based on program guide information acquired from a broadcast signal and the program identifier; starting a video-recording of the program at the broadcast start time which is brought forward when the bringing-forward is detected; and reproducing the video-recorded program at the broadcast start time before it is brought forward.

### BRIEF DESCRIPTION OF THE DRAWINGS

FIG. 1 is a block diagram showing a broadcast receiving apparatus according to an embodiment of the present invention

FIG. 2 is a schematic diagram showing an example of a reservation table T

FIG. 3 is a flowchart showing an example of an operation procedure of a broadcast receiving apparatus 100

FIG. 4 is a view showing a menu displayed at an on-timer reservation setting time

FIG. 5 is a view showing a menu displayed at the on-timer reservation setting time

FIG. 6 is a view showing a menu displayed at the on-timer reservation setting time

FIG. 7 is a view showing a menu displayed at the on-timer reservation setting time

### DETAILED DESCRIPTION OF THE INVENTION

Hereinafter embodiments of the present invention are described in detail with reference to the drawings.

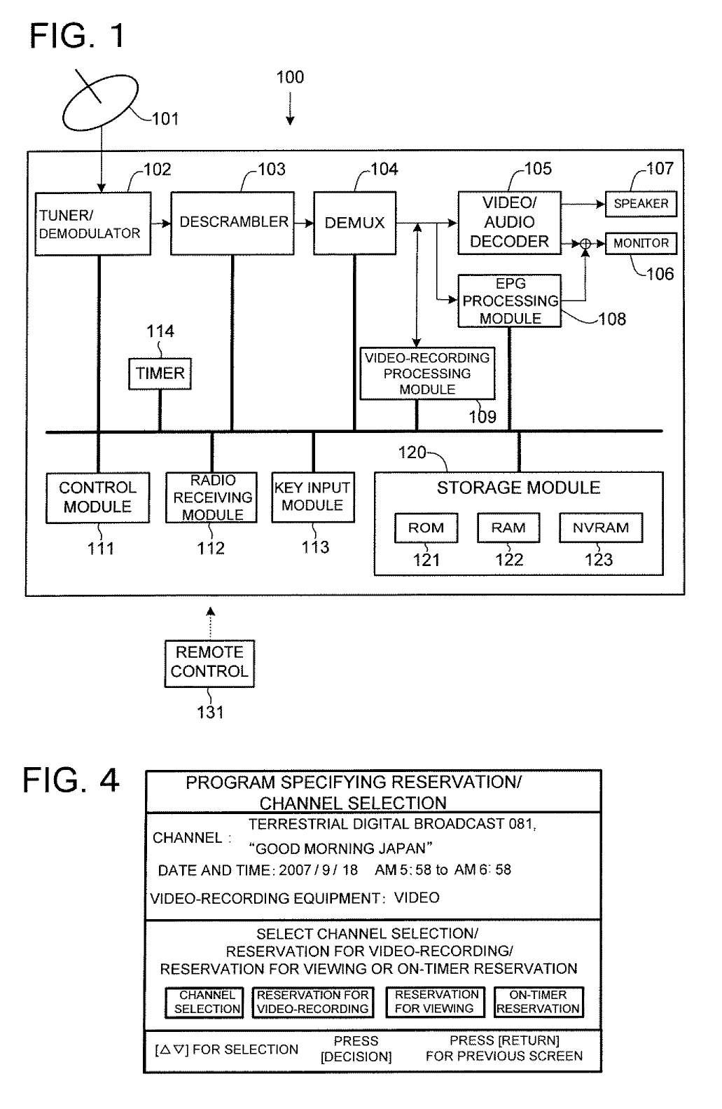

FIG. 1 is a block diagram showing a broadcast receiving apparatus 100 according to an embodiment of the present invention. The broadcast receiving apparatus 100 has an antenna 101, a tuner/demodulator 102, a descrambler 103, a demultiplexing module (DEMUX) 104, a video/audio decoder 105, a monitor 106, a speaker 107, an EPG processing module 108, a video-recording processing module 109, a control module 111, a radio receiving module 112, a key input module 113, a timer 114, and a storage module 120.

The antenna 101 receives broadcast signals transmitted from a broadcast station. The tuner/demodulator 102 selects a desired channel from the broadcast signals received by the antenna 101, demodulates it, and generates a transport stream (hereinafter, described as a TS). The generated TS is outputted to the descrambler 103. This TS is a multiplexed signal including a scrambled broadcast signal and an SI/PSI. The scrambled broadcast signal is a signal in which, for example, a broadcast signal in MPEG-2 is scrambled.

The SI/PSI is program arrangement information. The SI includes an SDT (Service Definition Table) and an EIT (Event Information Table) and soon. The SDT describes detailed information of a service (an organization channel). The EIT describes detailed information of programs within the service. An EPG (Electronic Program Guide) is created by mainly using the EIT. The PSI describes a constitution and so on of multiplexed plural programs, and includes a PAT (Program Association Table), a PMT (Program Map Table) and so on.

The descrambler 103 descrambles the TS inputted from the tuner/demodulator 102 to output to the demultiplexing module 104. Namely, the scrambled broadcast signal within the TS is descrambled and the broadcast signal is generated.

The demultiplexing module 104 demultiplexes the broadcast signal, the SI/PSI data and so on from the TS inputted from the descrambler 103. Besides, the demultiplexing module 104 outputs the demultiplexed broadcast signal to the video/audio decoder 105.

The video/audio decoder 105 decodes the broadcast signal inputted from the demultiplexing module 104, to output to the monitor 106 and the speaker 107. The monitor 106 is a display device such as a CRT and a liquid crystal display device. The speaker 107 is an audio output device.

The EPG processing module 108 constitutes EPG (Electronic Program Guide) information from the SI data demultiplexed by the demultiplexing module 104, and further, generates an image signal of the EPG. The EPG is displayed on the monitor 106 by the image signal. A user can confirm and reserve a program by using the EPG.

The video-recording processing module 109 video-records and reproduces a broadcast by using the broadcast signal outputted from the demultiplexing module 104. The EPG can be used for the reservation of the video-recording. Besides, the video-recording processing module 109 is used when a broadcast time of the program reserving an on-timer is brought forward as it is described. The video-recording processing module 109 has plural video-recording equipments (for example, a VTR (Video Tape Recorder), an HD (Hard Disk), a DVD (Digital Versatile Disk)), and they can be selected at the video-recording and reproducing time.

The control module 111 is constituted by a CPU (Central Processing Unit), and controls the whole of the broadcast receiving apparatus 100. The control module 111 performs the following processes.

### (1) Setting of On-Timer Reservation

The control module 111 sets an on-timer reservation. Namely, the control module 111 controls displays of various screens for an on-timer reservation, inputs and so on from a remote control 131 and so on. Namely, information for the on-timer reservation is inputted.

### (2) Generation of Reservation Table T

The control module 111 generates a reservation table T in which the information for the on-timer reservation is summarized, and stores it to an NVRAM 123.

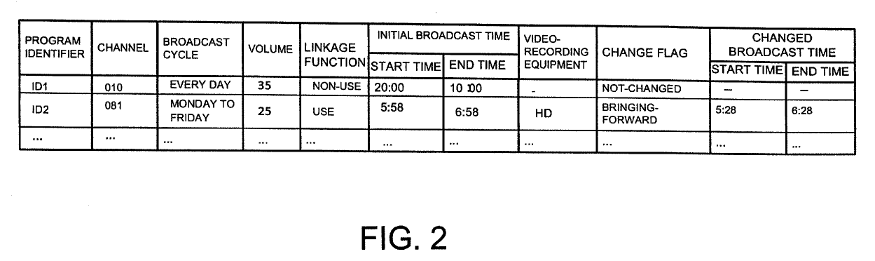

FIG. 2 is a schematic diagram showing an example of the reservation table T. A program identifier, a channel, a broadcast cycle, volume, a linkage function, an initial broadcast time, a video-recording equipment, a change flag, and a changed broadcast time are correspondingly shown. Among them, the program identifier, the channel, and the broadcast cycle can be acquired from the EPG.

The “program identifier” is an identifier to identify a broadcast program (a reserved program) reproduced at an on-timer operation time. For example, an event ID included in the EIT can be used as the program identifier. Besides, it is possible to use a combination of the information of the channel, a program name, a broadcast start date and time, and a broadcast end date and time, as the program identifier. When the program can be specified on the EIT, an appropriate program identifier can be used.

The “channel” represents a channel of the reserved program. The “broadcast cycle” represents a cycle in which the reserved program is broadcast. For example, “every day”, “Monday to Friday”, “every week” can be selected. The “volume” represents largeness of a reproduced sound at the on-timer operation time.

The “linkage function” represents whether the linkage function (a function linking to a change in the broadcast time) is used or not. When this field is “non-use”, the on-timer process is performed based on the initial broadcast time. Namely, the broadcast is reproduced based on the initial broadcast start time and channel regardless of the change in the broadcast time. On the other hand, when this field is “use”, an on-timer process corresponding to the change in the broadcast time (for example, the video-recording corresponding to a bring-forward of the broadcast time) is performed. As a result, a possibility in which the user can view the reserved program increases when the broadcast time is changed.

The “initial broadcast time” represents a broadcast start time and a broadcast end time of the program at the on-timer reservation time.

The “video-recording equipment” represents which one of the plural video-recording equipments in the video-recording processing module 109 is to be used for the video-recording and reproduction.

The “change flag” is information to distinguish whether the broadcast time is changed or not, and whether the broadcast time is brought forward or backward when it is changed. For example, they can be distinguished by “not-changed”, “bring-forward” and “bring-backward”. This field is made “not-changed” when the reservation table T is generated or the reserved program is added to the reservation table T.

The “changed broadcast time” represents a broadcast start time and a broadcast end time of the program when the broadcast time is changed. This field is made blank (“-”) when the reservation table T is generated or the reserved program is added to the reservation table T.

### (3) Detection of Change in Broadcast Time of Reserved Program

The control module 111 detects the change in the broadcast time of the reserved program. Namely, the control module 111 confirms whether the broadcast time of the reserved program is changed or not. For example, the change in the broadcast time of the reserved program is detected as stated below. Namely, the control module 111 searches the EIT within the broadcast signal by using the program identifier, and acquires information of the reserved program from the EIT. The control module 111 monitors whether the broadcast time is changed or not by comparing the information of the reserved program and the initial broadcast time in the reservation table T. This confirmation is performed, for example, periodically.

### (4) Rewriting of Reservation Table T

When the change in the broadcast time of the reserved program is detected, the control module 111 rewrites the reservation table T. Namely, the fields of the change flag and the changed broadcast time are rewritten as for the reserved program. The field of the “change flag” is rewritten into “bring-forward” or “bring-backward” in accordance with the bringing-forward or backward of the broadcast time. Besides, the changed start time and end time are written.

### (5) On-timer Process

The control module 111 performs the on-timer process. Namely, the control module 111 activates the broadcast receiving apparatus 100 and reproduces the reserved program in accordance with the reservation table T. This process corresponds to the change, the bringing-forward or backward in the broadcast time of the reserved program. Incidentally, details are described later.

The radio receiving module 112 receives user operational information transmitted from the remote control 131 in radio (for example, an infrared ray). The remote control 131 has a “cursor-moving” key, a “decision” key and a “return” key, and inputs of the user operational information are possible. A cursor displayed on a screen of the monitor 106 can be moved by operating the “cursor-moving” key. The cursor is moved on a menu displayed on the monitor 106, and thereby, an item on the menu is selected. A specification of the item is determined by pressing the “decision” key, and the screen moves to a next menu. It is possible to return to a prior menu by pressing the “return” key.

The key input module 113 is an input device inputting the user operational information, for example, a keyboard. The key input module 113 has a “cursor-moving” key, a “decision” key and a “return” key, and the inputs of the user operational information are possible as same as the remote control 131. The timer 114 shows a current time, and it is used for the later-described on-timer process.

The storage module 120 is constituted by a ROM (Read Only Memory) 121, a RAM (Random Access Memory) 122, and the NVRAM (Non Volatile RAM) 123. The ROM 121 stores programs and so on to operate the control module 111. The RAM 122 is used at the operation time of the control module 111, and programs, data and so on are written thereto. The NVRAM 123 stores the reservation table T.

### (Operations of Broadcast Receiving Apparatus 100)

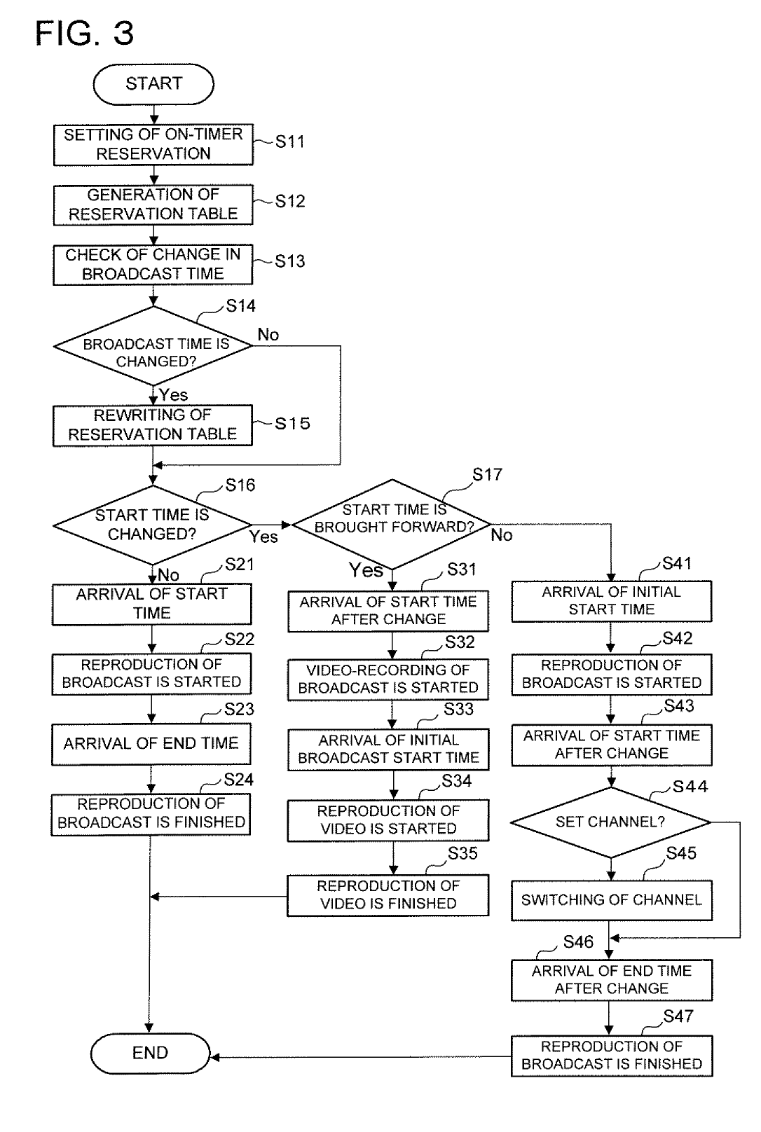

Hereinafter, an operation procedure of the broadcast receiving apparatus 100 is described. FIG. 3 is a flowchart showing an example of the operation procedure of the broadcast receiving apparatus 100. FIG. 4 to FIG. 7 are views showing menus displayed on the monitor 106 at the on-timer reservation setting time.

### (1) Setting of On-timer Reservation (Step S11)

The user sets an on-timer reservation. For example, an electronic program guide is displayed on the monitor 106, then a program is specified from the electronic program guide, and thereby, it becomes possible to set the program as an object of the on-timer reservation.

FIG. 4 is the view showing an example of a menu (a menu for a program specifying reservation/a channel selection) displayed when the program is specified from the electronic program guide. A channel of the specified program (terrestrial digital broadcast 081), a title (Good Morning Japan), the broadcast start date and time and the broadcast end date and time ( Sep. 18, 2007, Am 5:58 to AM 6:58) are displayed on the screen.

Here, a button of the “on-timer reservation” is selected by operating the “cursor-moving” key of the remote control 131, and the “decision” key of the remote control 131 is pressed. As a result, the selected program becomes the object of the on-timer reservation, and the screen moves to a menu for the on-timer reservation.

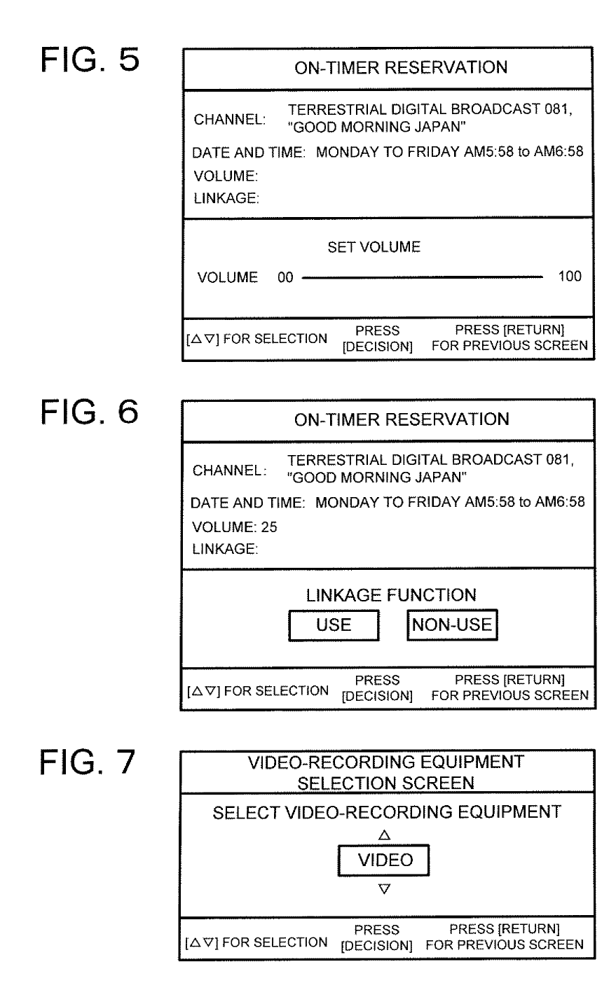

FIG. 5 is the view showing an example of the menu for the on-timer reservation. Here, the channel of the selected program, the broadcast start time, the broadcast end time, and the broadcast cycle are displayed. Namely, information of the selected program is extracted from the electronic program guide, and automatically inserted into the menu. Incidentally, the information of the program can be inputted from the remote control 131 and so on.

Here, the volume is selected by operating the “cursor-moving” key of the remote control 131, and the “decision” key of the remote control 131 is pressed. As a result, the volume at the on-timer operation time is determined, and the screen moves to a menu for the linkage function setting.

FIG. 6 is the view showing an example of the menu for the linkage function setting. Whether the linkage function is used or not can be selected by this menu. This linkage function is a function linking to the change in the broadcast time of the reserved program, as it is described in the description of the reservation table T. The user can view the reserved program by using the linkage function even when the broadcast time is changed.

The “non-use” of the linkage function is selected by operating the “cursor-moving” key of the remote control 131, then the “decision” key of the remote control 131 is pressed, and the on-timer reservation is finished. On the other hand, the “use” of the linkage function is selected, and the “decision” key of the remote control 131 is pressed. As a result, the usage of the linkage function is determined, and the screen moves to a menu for the video-recording equipment selection. Hereinafter, it is described on a basis of using the linkage function.

FIG. 7 is the view showing an example of the menu for the video-recording equipment selection. The video-recording equipment is selected by operating the remote control 131, and the “decision” key of the remote control 131 is pressed. As a result, the video-recording equipment is specified, and the menu of the on-timer reservation is finished.

### (2) Generation of Reservation Table T (Step S12)

The reservation table T is created or the reserved program is added to the existing reservation table T based on the setting of the on-timer reservation (refer to FIG. 2). The program identifier, the channel, the broadcast cycle, the volume, the linkage function, the initial broadcast time, the video-recording equipment, the change flag, and the changed broadcast time are correspondingly shown in the reservation table T. At this time, the field of the “change flag” in the reservation table T is set as “not-changed”, and the field of the changed broadcast time is made blank as for a newly reserved program.

### (3) Detection of Change in Broadcast Time of Reserved Program (Step S13)

The control module 111 detects the change in the broadcast time of the reserved program. Namely, the control module 111 acquires the information of the reserved program from the EIT, and monitors whether the broadcast time thereof is changed or not. This confirmation is performed, for example, periodically.

### (4) Rewriting of Reservation Table T (Steps S14, S15)

When the change in the broadcast time of the reserved program is detected, the control module 111 rewrites the reservation table T. Namely, the fields of the change flag, the changed broadcast time are rewritten.

### (5) On-timer Process (Steps S16, S17, S21 to S24, 531 to S35, S41 to S47)

The on-timer process is performed based on the reservation table T. The control module 111 performs different processes in accordance with the “change flag” (steps S16, S17). Namely, process contents are different depending on the broadcast time being any of not changed, brought forward, or brought backward.

a. Broadcast Time Unchanged Case (Steps S21 to S24)

When the broadcast time is not changed, the reproduction of the program is started with the set channel and volume at the time when the broadcast start time arrives (steps S21, S22). When the broadcast end time arrives, the reproduction of the program is finished (steps S23, S24).

b. Broadcast Time With Brought Forward Case (Steps S31 to S35)

When the broadcast time is brought forward, the video-recording of the reserved program by the set video-recording equipment is started at the time when the changed broadcast start time arrives (steps S31, S32). At this time, the program is not reproduced. This video-recording continues until the end of the reserved program.

Besides, the reproduction of the video-recorded program is started at the set time (at the initial broadcast start time) (steps S33, S34). At this time, the video-recording and the reproduction of the reserved program are simultaneously performed if the reserved program is not finished (so-called a follow-up reproduction). The broadcast receiving apparatus 100 is in inactive state when the reproduction of the vide-recorded program is finished (step S35). Namely, the reproductions of not only the video-recorded program, but also a program on the air are not performed.

Incidentally, when the user operates the remote control 131 and so on during the reproduction of the video-recorded program, an active state of the broadcast receiving apparatus 100 is kept when the reproduction of the video-recorded program is finished. Namely, when the reproduction of the video-recorded program is finished, the program on the air is reproduced subsequently.

c. Broadcast Time With Brought Backward Case (Steps S41 to S47)

When the broadcast time is brought backward, the reproduction of the program on the air is started at the initial broadcast start time (steps S41, 542). At this time, the set channel and volume are applied. On the other hand, the user can change the channel and volume by using the remote control 131 and so on.

When the broadcast start time after change arrives, the channel is switched to the set channel if it is changed from the set channel (steps S43 to S45). Namely, the program of the set channel is reproduced at the broadcast start time after change. After that, the reproduction of the program is finished when the changed broadcast end time arrives (steps S46, S47). Namely, the broadcast receiving apparatus 100 becomes in inactive state.

Incidentally, when the user operates the remote control 131 and so on during the reproduction of the program, the active state of the broadcast receiving apparatus 100 is kept even if the broadcast end time arrives. Namely, the reproduction of the program on the air continues without interruption.

As stated above, the video-recording, the switching of the channel are performed with correspond to the change in the broadcast time of the reserved program by using the “linkage function”. Accordingly, the user can view the reserved program when the broadcast receiving apparatus 100 is automatically activated by the on-timer.

Incidentally, when the “linkage function” is not used, the processes corresponding to the steps S31 to S35, S41 to S47 in FIG. 3 are not performed, and the reproduction of the broadcast is started and finished according to the initial broadcast time regardless of whether the broadcast time of the reserved program is changed or not.

### Other Embodiments

Embodiments of the present invention are not limited to the above-stated embodiments, and can be expanded/modified without departing from the spirit or essential characteristics thereof, and such expanded/modified embodiments are also included in the technical scope of the present invention.

What is claimed is:

1. A broadcast receiving apparatus, comprising:
a storage module storing a table correspondingly showing a program identifier identifying a broadcast program, and a broadcast start time of the program;
a detecting module detecting whether the broadcast start time is brought forward or not based on program guide information acquired from a broadcast signal and the program identifier;
a video-recording module starting a video-recording of the program at the broadcast start time which is brought forward when the bringing-forward is detected; and
a reproduction module reproducing the video-recorded program at the broadcast start time before it is brought forward.

2. The broadcast receiving apparatus according to claim 1, further comprising:
a second detecting module detecting whether the broadcast start time is brought backward or not based on the program guide information;
a second reproduction module reproducing a program which is broadcast at the broadcast start time before it is brought backward; and
a changing module changing a channel of the program at the broadcast start time which is brought backward when the bringing-backward is detected.

3. The broadcast receiving apparatus according to claim 1,
wherein the table further shows a broadcast end time of the program, and
wherein the reproduction module finishes the reproduction of the program at the broadcast end time.

4. The broadcast receiving apparatus according to claim 1, further comprising:
an input module inputting information, and
wherein the finishing of the reproduction at the reproduction module is terminated based on the input of the information.

5. The broadcast receiving apparatus according to claim 1, further comprising a display module displaying video of the reproduced program.

6. A broadcast receiving method, comprising:
storing a table correspondingly showing a program identifier identifying a broadcast program, and a broadcast start time of the program;
detecting whether the broadcast start time is brought forward or not based on program guide information acquired from a broadcast signal and the program identifier;
starting a video-recording of the program at the broadcast start time which is brought forward when the bringing-forward is detected; and
reproducing the video-recorded program at the broadcast start time before it is brought forward.

7. The broadcast receiving method according to claim 6, further comprising:
detecting whether the broadcast start time is brought backward or not based on the program guide information;
reproducing a program which is broadcast at the broadcast start time before it is brought backward; and
changing a channel of the program at the broadcast start time which is brought backward when the bringing-backward is detected.

8. The broadcast receiving method according to claim 6,
wherein the table further shows a broadcast end time of the program, and
the broadcast receiving method further comprising:
finishing the reproduction of the program at the broadcast end time.

9. The broadcast receiving method according to claim 6, further comprising:
inputting information; and
terminating the finishing of the reproduction of the program based on the input of the information.

10. The broadcast receiving method according to claim 6, further comprising displaying video of the reproduced program.
